(19) United States
(12) Patent Application Publication
(10) Pub. No.: US 2017/0358009 A1
(43) Pub. Date: Dec. 14, 2017

(54) ONLINE AD AUCTION BASED ON PREDICTED AD SPACE VIEW-ABILITY

(71) Applicant: AppNexus, Inc., New York, NY (US)

(72) Inventors: Yash Shah, New York, NY (US); Abe Greenstein, New York, NY (US); Tanguy Le Meur, New York, NY (US); Kevin Solinger, New York, NY (US)

(21) Appl. No.: 15/180,913

(22) Filed: Jun. 13, 2016

(51) Int. Cl. G06Q 30/02

(52) U.S. Cl. CPC G06Q 30/0275; G06Q 30/0264

(57) ABSTRACT

Methods, systems, and apparatus, including computer programs encoded on a computer storage medium, for receiving a notification of an ad space, the ad space being for presentation in a user interface of an application executing on a client device, sending, to the client device, instructions configured to be executed by the client device for determining view-ability data of the ad space, the view-ability data comprising whether the ad space is within a viewport of the user interface, receiving, from the client device, the view-ability data as determined by the instructions at a first time instance, calculating a predicted view-ability that the ad space is positioned within the viewport at a second time instance after the first time instance, and sending, to a plurality of bidders, a bid request for bidding on an auction of the ad space, the bid request comprising the predicted view-ability.

### BACKGROUND

This specification relates to online advertising and, more particularly, ad space auctions.

Online display advertising delivers promotional messages to consumers by using visual advertisements (or “ads”) in web pages. A publisher of a web page can insert an ad space in a web page. An ad space is a region of a web page (or other electronic document) where an advertisement can be placed. When the web page is displayed in a browser, a visual advertisement (a “creative”) of an advertiser can be dynamically retrieved from an ad server for the advertiser, and displayed in the ad space. The act of serving a creative on a web page for displaying is often referred to as an impression.

An ad space inventory is a collection of one or more ad spaces on web pages served by a publisher's web sites. Publishers can sell their ad space inventories to advertisers. Multiple publishers and multiple advertisers can participate in auctions in which selling and buying of ad space inventories take place. Auctions can be conducted by an ad network or ad exchange that brokers between a group of publishers and a group of advertisers.

Selling and buying ad spaces can be based on pricing or payment models such as cost per thousand impressions (CPM), cost per click (CPC), and cost per action or acquisition (CPA). In the CPM model, advertisers typically pay for every impression of their advertisement; the price paid for each impression is measured in price per 1000 (“mille”) impressions. In the CPC model, advertisers typically pay each time a viewer clicks on their advertisement. In the CPA model, advertisers pay for every action, such as a sale or registration, completed as a result of a viewer clicking on their advertisement.

### SUMMARY

In general, one aspect of the subject matter described in this specification can be embodied in methods that include the actions of performing by one or more computers, receiving a notification of an ad space, the ad space being part of an ad space inventory of a seller, the ad space being for presentation in a user interface of an application executing on a client device of a user, sending, to the client device, instructions configured to be executed by the client device for determining view-ability data of the ad space, the view-ability data comprising whether the ad space is within a viewport of the user interface, receiving, from the client device, the view-ability data as determined by the instructions at a first time instance, calculating a predicted view-ability that the ad space is positioned within the viewport at a second time instance after the first time instance, wherein calculating the predicted view-ability uses a prediction model comprising one or more features, and sending, to a plurality of bidders, a bid request for bidding on an auction of the ad space, the bid request comprising the predicted view-ability. Other embodiments of this aspect include systems, apparatus, and computer programs.

These and other aspects can optionally include one or more of the following features. The aspect can further comprise receiving, from one or more of the bidders, bids in response to the bid request. Each bid can comprise a respective bid price as determined by a respective bidder according to the predicted view-ability. The view-ability data as determined by the instructions at the first time instance can further comprise a position of the ad space relative to the viewport or a size of the viewport. A particular feature can describe the ad space, the ad space inventory, the application, the client device, or the user. A particular feature can comprise one or more of an identifier of the ad space, web domain for the ad space, and identifier of the application. The prediction model can be a logistic function of the features, the logistic function comprising respective coefficients for the features.

Particular implementations of the subject matter described in this specification can be implemented to realize one or more of the following advantages. An ad space auctioning system auctions an available ad space based on a view-ability of the ad space. The system receives an ad call for an available ad space from a client device. Instead of immediately auctioning off the ad space, the system first sends instructions to the client device to determine view-ability data of the ad space. View-ability data of the ad space can include whether the ad space is currently in view, for example. After receiving the determined view-ability data from the client device, the system calculates a predicted view-ability for the ad space. The system then conducts an auction of the ad space by sending to multiple bidders a bid request that include the predicted view-ability. In this way, instead of bidding on the auction without knowledge of whether its creative served to the ad space is going to be viewed, a bidder can bid on the ad space with a bid price determined based on the predicted view-ability for the ad space.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for ad space auctions.

FIG. 2 is an example web browser window displaying a scrollable web page.

FIG. 3 is a data flow diagram of an example method for auctioning an available ad space based on view-ability of the ad space.

FIG. 4 is a flowchart of another example method for auctioning an available ad space based on a view-ability of the ad space.

Like reference numbers and designations in the various drawings indicate like elements.

### DETAILED DESCRIPTION

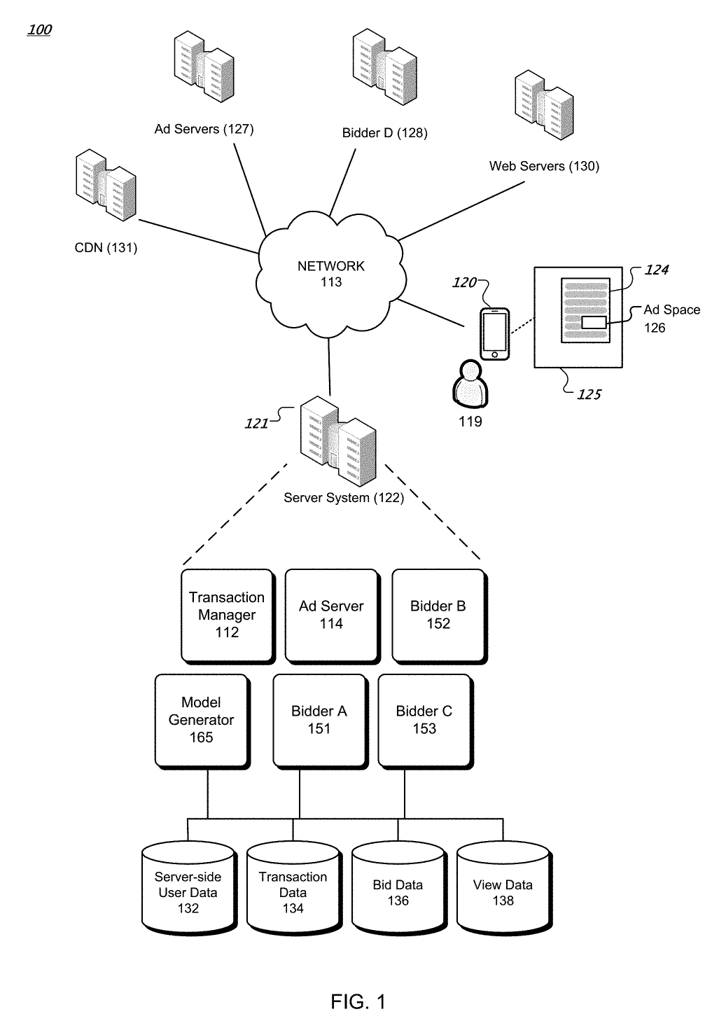

FIG. 1 illustrates an example system 100 for ad space auctions. A server system 122 provides functionality for real-time ad space auctions. The server system 122 comprises software components and databases that can be deployed at one or more data centers 121 in one or more geographic locations, for example. The server system 122 software components comprise a transaction manager 112, ad server 114, one or more bidders (e.g., bidder A 151, bidder B 152, and bidder C 153), and model generator 165. The server system 122 can also include one or more software components for load balancing tools and security tools. The load balancing tools manage traffic within a single data center or between multiple data centers. The security tools manage data protection and access privilege for tenants served by the data centers 121. The software components can comprise subcomponents that can execute on the same or on different individual data processing apparatus. The software components can also be combined. The server system 122 databases comprise a server-side user data database 132, transaction data database 134, bid data database 136, and view data database 138. The databases can reside in one or more physical storage systems. The software components and databases will be further described below.

The transaction manager 112 (“impression bus” or simply “Imp Bus”) is an auction system that facilitates the transaction aspects of ad space inventory and impression trading between buyers and sellers. A buyer can be an advertiser (e.g., a credit card company, a sportswear company), an ad network, or an advertising agency, for example. Other buyers are possible. A seller can be a publisher (e.g., newspaper or social network), an online streaming or gaming service, or an ad network. Other sellers are possible. The transaction manager 112 processes ad requests received from web browsers or other software applications displaying content from publishers, sends relevant information to advertisers, conducts auctions (e.g., on behalf of sellers), returns creatives to the browsers or other applications, keeps track of billing and usage for advertisers and publishers, returns auction-result data, and enforces quality standards, for example. The transaction manager 112 stores in the transaction data database 134 various transaction information for each ad space that is transacted by the transaction manager 112 or other software components of the server system 122.

The ad server 114 is a software component that serves creatives to web pages or other applications. The ad server 114 can also make decisions about what creatives to serve, and track clicks or other user interactions with creatives, for example. A creative can be a visual or audio advertisement such as an image, an animation, a video clip, or an audio clip. Other types of a creative are possible.

A bidder system or bidder (e.g., bidder A 151) is a software component that, on behalf of a buyer, performs bidding operations. The bidder takes various pieces of bid-specific information (e.g., maximal bid price, target user areas or segments, start and end dates, budget) as input and generates a bid for a particular item of an ad space inventory, for example. A buyer can set up (e.g., through an API or web pages provided by the server system 122) a campaign targeting an ad space inventory with a set of bid-specific information for the ad space inventory and store the bid-specific information in bid data database 136. In some implementations, a bidder can be remote from the server system 122, such as bidder D 128. Here, an ad space inventory can be a collection of one or more ad spaces on web pages served by a publisher's web site. An ad space inventory can also be a collection of one or more ad spaces in user interfaces presented by a software application published by a publisher. Other collections of ad spaces of an ad space inventory are possible.

The transaction manager 112 conducts an auction when receiving an ad request for filling an available ad space. By way of illustration, a graphical user interface 124 of a software application 125 executing on client device 120 of a user 119 can include an ad space 126 and a corresponding ad tag. The application 125 can be a web browser application, or a software application such as a game application or a maps application. For instance, a web page displayed in a browser window of a web browser (e.g., running on a personal computer) can include an ad space on the web page and a corresponding ad tag. By way of illustration, the ad space can appear at the bottom of the user interface (a “banner ad”) with a corresponding ad tag. Other examples of ad spaces are possible. Here, the client device 120 can be a mobile phone, a smartwatch, a tablet computer, a personal computer, a game console, or an in-car media system. Other examples of a client device are possible. In some implementations, an ad tag comprises a Uniform Resource Locator (URL) from which an ad will be requested (e.g., a URL for the server system 122), Hypertext Markup Language (HTML) statements and/or JavaScript instructions for retrieving and displaying a creative (e.g., displaying the creative in a 160×600 iframe). The application 125 running on the client device 120 can retrieve content in the user interface 124 (e.g., a web page) through one or more data communication networks 113 such as the Internet, for example, from web servers 130 of a publisher. The ad tag causes the application 125 to send (e.g., through the networks 113) an ad request (“ad call”) to the server system 122. In some implementations, the application 125 sends an ad request to the server system 122 via another advertising server system such as an ad exchange. The ad request can include information about the available ad space 126 (e.g., a size for the ad space, an identifier for the publisher), user information (e.g., an identifier of the user 119, an Internet Protocol or IP address), and system information (e.g., types of the browser and the client device), for example. The ad request can be composed in JavaScript Object Notation (JSON) or Extensible Markup Language (XML) format and transmitted to the server system 122 using Hypertext Transfer Protocol (HTTP) protocol (e.g., using HTTP POST request method). Other ad request formats and transmission methods are possible.

In response to the ad request, the transaction manager 112 can access the server-side user data store database 132 based on the user's identifier (if available), and retrieve available information about the user (e.g., user segment information such as age, gender, interests, or location). The transaction manager 112 generates a bid request including information about the ad space, the user, and so on, and sends the bid request to multiple bidders such as bidder A 151 and bidder B 152. The transaction manager 112 can also send the bid request through the networks 113 to servers of bidder D 128, which is external to the server system 122. The bid request can be composed in JSON format and sent to bidders using HTTP POST. The bid request can also be encoded or compressed. Other bid request formats and transmission methods are possible.

Each bidder can determine an appropriate bid based on its own requirements (e.g., budget, targets in placements) and submit a bid response including a bid price and an identifier of a creative to be served, for example, to the transaction manager 112 (or not to respond at all). The transaction manager 112 determines a winning bid (e.g., a highest bid) among bid responses received within a specified time period (e.g., 100 milliseconds). The transaction manager 112 then returns a creative of the winning bid to the client device 120, causing the application 125 to display the creative in the ad space in the user interface 124. The transaction manager 112 can also return a URL for a creative of the winning bid to the client device 120, causing the application 125 on the client device 120 to retrieve the creative from an ad server (e.g., ad server 114, or ad servers 127 external to the server system 122), or from servers of a content distribution network (CDN) 131. In various implementations, the transaction manager 112 can store in the transaction data database 134 transaction information such as an identifier of the creative served to the ad space, an identifier of the winning buyer, the user's identifier, the winning bid price, an identifier of the ad space, an identifier of the seller of the ad space, and a time stamp. The winning bid price (i.e., the price paid by the winning buyer) can be the bid price submitted by the winning buyer, or a second highest bid price of the auction as determined by Vickrey auction or other second-price auction mechanisms. Other transaction information of a transaction is possible.

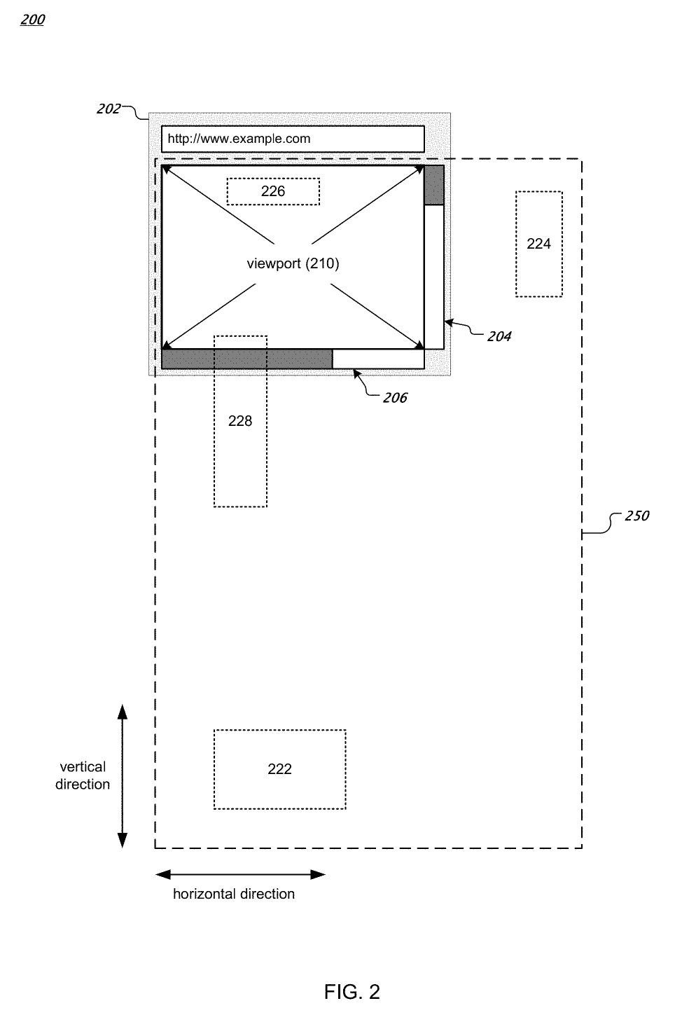

A viewport of the user interface 124 is an area of the user interface 124 within which content presented by the user interface 124 is viewable (visible) to the user 119. The ad space 126 may not necessarily be visible in the viewport of the user interface 124. For instance, a viewport can be a display area of a web browser window displaying a scrollable web page. An ad space at the bottom of the web page may not be in the display area, for instance, when the display area shows the top-half of the web page. FIG. 2 is an example web browser window displaying a scrollable web page. In FIG. 2, a web browser window 202 displays a portion of a scrollable web page 250. The browser window 202 includes a vertical scroll bar 204 for scrolling the web page 250 in the vertical direction. The browser window 202 also includes a horizontal scroll bar 206 for scrolling the web page 250 in the horizontal direction. As shown in FIG. 2, only a portion of the web page 250 is viewable in the browser window's display area or viewport 210. For an ad space (e.g., ad space 226) that is within the viewport 210, the ad space is viewable (in the viewport 210). For an ad space that is beyond the viewport 210 in the vertical direction (e.g., ad space 222) or beyond the viewport 210 in the horizontal direction (e.g., ad space 224), the ad space is not viewable. For an ad space (e.g., ad space 228) that straddles a border of the viewport 210 but is partially within the viewport 210, the ad space is considered viewable in some implementations. In further implementations, an ad space is considered viewable if at least 50% of the ad space is in view for at least one second or other minimum time period. In some implementations, an ad space can be considered as viewable only if the entire ad space is within the viewport 210.

When a creative of a winning bidder is served to the user interface 124 for displaying in the ad space 126 (i.e., an impression), but the ad space 126 is not in the viewport of the user interface 124, the creative in the ad space is not viewable to the user 119, thus has little or no effect in advertising to the user 119 for the winning bidder.

It is desirable for bidders on an auction of an available ad space to know, before submitting bids on the ad space, how probable it is that the ad space may be viewable to a user when a creative is served to the ad space. Particular implementations of the subject matter described in this specification describe methods for auctioning an available ad space based on view-ability of the ad space. The predicted view-ability of an ad space is the probability that, when a creative is served to the ad space, the ad space will be viewable to a user. When a notification of an available ad space is received by the system 122 from a client device (e.g., client device 120), the system 122 transmits instructions to the client device to determine real-time view-ability data of the ad space. The determined view-ability data is then sent from the client device to the system 122. After receiving the view-ability data, the system 122 calculates a predicted view-ability for the ad space using a prediction model. A prediction model can be a mathematical formula that predicts the view-ability for an ad space based on the real-time data and historical information.

Other prediction models are possible. For instance, a prediction model can be a data structure (e.g., a graph, a lookup table) that can be used to predict the view-ability of an ad space based on real-time view-ability data of the ad space. Particular implementations conduct an auction on the ad space by sending a bid request to multiple bidders that includes the predicted view-ability. In this way, the bidders can submit their respective bids on the auction based on the predicted view-ability.

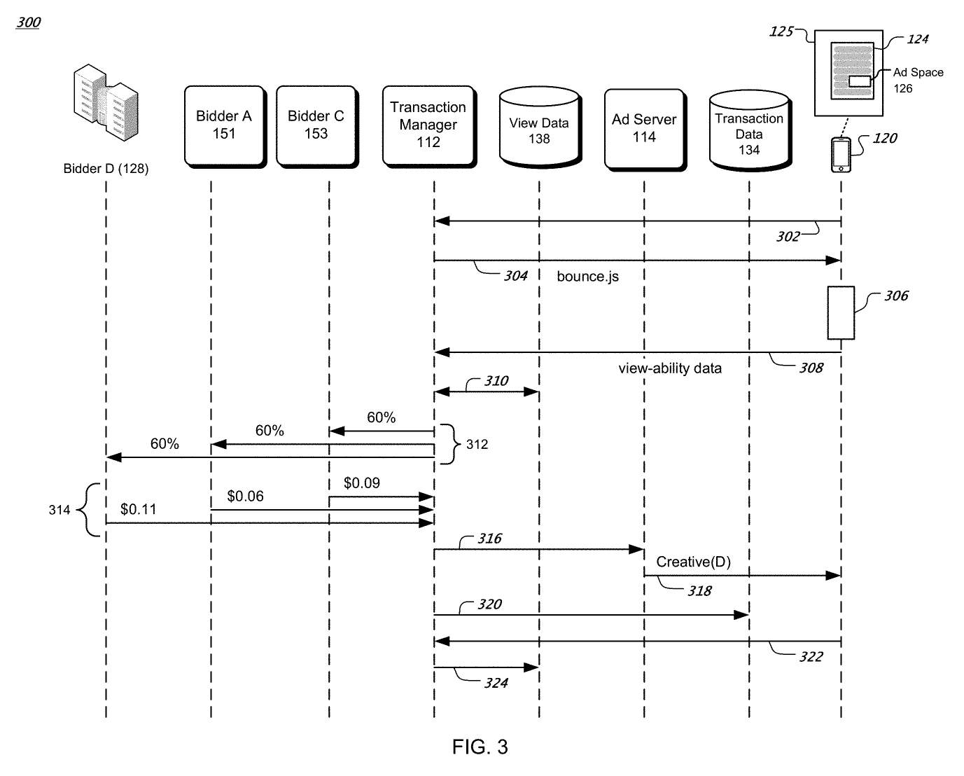

FIG. 3 is a data flow diagram of an example method for auctioning an available ad space based on view-ability of the ad space. The example method can be implemented by the transaction manager 112, for example. In FIG. 3, the transaction manager 112 receives a notification (an ad call) of the ad space 126 that is for presentation in the user interface 124 of the application 125 executing on the client device 120 (302). Instead of sending a bid request to bidders, the transaction manager 112 first sends to the client device 120 instructions “bounce.js” (304). The instructions can be JavaScript or Java programming language instructions, for example. Other types of instructions are possible. The instructions are configured to be executed by the client device 120 for determining view-ability data for the ad space 126 (306). View-ability data for the ad space 126 can include an indication of whether the ad space 126 is within a viewport (“in view”) of the user interface 124, for example. For instance, the instructions can determine whether a Document Object Model (DOM) element corresponding to the ad space 126 is within a bounding box corresponding to a viewport of the user interface 124. The instructions can be executed by the application 125 and determine whether ad space 126 is within the viewport, and send back to the transaction manager 112 a message indicating whether the ad space 126 is in view within the viewport (308). For instance, the message can include a flag with value of 1 indicating that the ad space is in view within the viewport, or value of 0 indicating otherwise. In addition to whether the ad space 126 is within a viewport of the user interface 124, the instructions can also determine other view-ability data of the ad space 126. For instance, the instructions can determine a position of the ad space 126 (e.g., horizontal and vertical distances in pixels from the top left corner of the viewport), and a size (e.g., in pixels) of the viewport, and send back to the transaction manager 112 the determined position of the ad space 126 and size of the viewport. The position of the ad space 126 relative the size of the viewport can indicate how probable the ad space 126 may be within the viewport at a later time, if the ad space 126 is not already within the viewport, for example. The instructions can send back to the transaction manager 112 an error message if the instructions cannot determine view-ability data of the ad space 126 (e.g., when the user interface 124 is hidden behind another user interface).

In some implementations and by way of illustration, the instructions can comprise Javascript function:

getViewabilityData: function(e) {
var t, n, r, o = 0,

i = this.isFriendlyFrame( );

if (!i && void 0 === e.mozInnerScreenY) return {

s: 1

};
if (i) {

var c = this.injectVirtualElement( );
t = this.getAbsolutePosition(e, c) ;
for (var d, a, s = e; s != e.top;) {

try {

a = s.frameElement

} catch (u) {

return {

s: 4

}

}
if (null === a) return {

s: 5

};
s = s.parent, d =

this.getAbsolutePosition(s.parent, a), t = {
x: t.x + d.x,
y: t.y + d.y

}

}
var l = s.innerWidth | |

s.document.documentElement.clientWidth | |
s.document.body.clientWidth,

f = s.innerHeight | |

s.document.documentElement.clientHeight | |
s.document.body.clientHeight;

r = {

x: l, y: f

}, n = this.isInView(t, l, f)

} else void 0 !== e.mozInnerScreenY && (t = {

x: e.mozInnerScreenX − e.screenX − 4,
y: e.mozInnerScreenY − e.screenY − 40

}, r = {

x: screen.width − 8,
y: screen.height − 119

}, n = this.isInView(t, r.x, r.y));
return (void 0 !== n && void 0 !== document.hidden
&& document.hidden | | i &&
!e.top.document.hasFocus( )) && (n = !1, o = 3), {

p: t, w: r, v: n, s: o

}

}

};
var c = function(n) {

var r, o = “”;
try { n = e(n, 0);

var c = e(new i(n), 1),

d = c.getViewabilityData(window);

void 0 !== d.v && (o += “&” + n.iv + “=” + (d.v ?
1 : 0)), void 0 !== d.p && (o += “&” + n.pos + “=”
+ Math.round(d.p.x) + “,” + Math.round(d.p.y)),
void 0 !== d.w && (o += “&” + n.ws + “=” +
Math.round(d.w.x) + “,” + Math.round(d.w.y)), r =
d.s, window._anxpv = d

} catch (a) {

“undefined” != typeof console, r = 2, t(a,
“AnViewModule::executeViewability”)

}
return void 0 !== r && (o += “&” + n.vs + “=” +

r), “undefined” != typeof console, o

};;

The view-ability data returned by the function above comprises the viewport's width and height, the position of the top left pixel of the adspace (x and y), and a binary flag that indicates whether the position is within the viewport or not at the time of pre-bid. The position and viewport size are used to compute the relative position of the top left pixel by breaking the screen of the client device into 25 buckets: 5 buckets along the height and 5 buckets along the width and determining which bucket the x and y position falls in. The bucketed relative position x and y and the binary flag are used as additional features X in the model described below. After receiving from the client device 120 the view-ability data determined by the instructions, the transaction manager 112 calculates a predicted view-ability for the ad space 126.

The view-ability is a probability that the ad space 126 is positioned within the viewport at a time instance after the previous time instance when the instructions determined the view-ability data of the ad space 126, for example. More particularly, the view-ability can be a probability that the ad space 126 is positioned within the viewport or a part of the view port when a creative is served to the ad space.

The transaction manager 112 can calculate a predicted view-ability for the ad space 126 using a prediction model of one or more discrete features or parameters. A feature can be a parameter describing the ad space 126 (e.g., an ad tag identifier), an ad space inventory the ad space 126 belongs to (e.g., a web address for the web domain of the ad space inventory), the application 125 (e.g., an application identifier), the client device 120 (e.g., a device identifier, or a device type identifier), or the user 119 (e.g., a user identifier). A feature can also be a combination of one or more of these features. For instance, a feature can be a combination of ad space and ad space inventory, a combination of ad space and application, or a combination of ad space inventory and application. Other combinations are possible.

By way of illustration, the prediction model can be a logistic function of one or more features with coefficients for the features as follows:

$$p = \frac{1}{1 + {e}^{- ( {β}_{0} + {X}_{1} {β}_{1} + … + {β}_{n} {X}_{n} )}}$$

In the logistic function above, p is a predicted view-ability. X₁, . . . , Xₙ are n features. β₀, β₁, . . . , βₙ are coefficients. The transaction manager 112 can access the view data database 138 for coefficients of the logistic function (310) and the historical view rates for each of the features, and calculate a predicted view-ability for the ad space 126 using the logistic function.

After calculating a predicted view-ability of the ad space 126, the transaction manager 112 conducts an auction on the ad space 126 by sending a bid request to multiple bidders, for example, bidder C 153, bidder A 151, and bidder D 128 (312). In addition to ad space and user information, the bid request includes the predicted view-ability (e.g., 60%) calculated with the prediction model. In this way, a bidder can determine its bid price of the ad space 126 based on the predicted view-ability. In some implementations, the bidder can submit a CPM or CPC bid at a price deemed appropriate based on the predicted view-ability, or the bidder can submit a cost-per-view (CPV) bid. In a CPV model, advertisers typically pay each time their advertisement is viewed by a user. The transaction manager will calculate a corresponding estimated CPM (eCPM) bid for use in the auction bid ranking. An estimated CPM (eCPM) bid is a CPV bid multiplied by the predicted view-ability. For instance, the bidder A may determine a CPV bid price of $0.10 for an ad space of the ad space inventory including the ad space 126. Based on the predicted view-ability of 60% in that the ad space 126 may be viewed by a user (the user 119), the transaction manager will discount the bid price for the ad space 126 to $0.06. In some implementations, a seller is able to set an eCPM floor price for their inventory which serves as a minimum bid for eCPM bids. In a second-price auction, the eCPM bid can act as the second price in the auction should a non-eCPM bid win. Other methods for bidding for an ad space by a bidder based on a predicted view-ability of the ad space are possible. For instance, a bidder may forgo submitting a bid on the auction if the bidder determines that the predicted view-ability is less than a specific threshold (e.g., less than 35%).

If a eCPM bid wins an auction, the transaction manager 112 will log the transaction except that the transaction will have no cost to the buyer or revenue to the seller. An encoded data structure, which includes the transaction ID and the CPV price, is then served with the creative and a viewability measurement script (described below). The measurement script executes in the client devices, determines whether the creative associated with the bid was viewable, and sends the measurement results back to the transaction manager 112 including the encoded data structure. If the measurement results indicate that the creative is viewable, the transaction manager 112 will log the cost information for the transaction and send notification to the bidder that the CPV bid was viewed and therefore charged.

Bidders can send their respective bid price for the ad space 126 to the transaction manager 112 (314). In FIG. 3, the transaction manager 112 selects the highest bid price of $0.11 from the bidder D, and notifies the ad server 114 (316). The ad server 114 then in turns sends a creative for the bidder D to the client device 120 to be served to the ad space 126 318). In addition, the transaction manager 112 records transaction information (e.g., winning bid price, winning buyer, the ad space 126, time stamp, and so on) in the transaction data database 134 (320).

In some implementations, after the creative for the bidder D is served to the ad space 126, instructions (e.g., JavaScript) can determine whether the ad space 126 is in view of the user interface 124, and send back to the transaction manager 112 a message indicating whether the ad space (containing the creative for the bidder D) is in view in the user interface 124 (322). The instructions check that an actual ad is present (verses just a container for an ad). They also measures according to one or more definitions of a “viewable” impression, which generally is a function of how much of the ad is in-view and a for how long. The measurement data determined by the instructions is a ‘result’ with three options—1) unable to measure, 2) measured not viewable, 3) measured viewable. The measurement data will also include the definition id that the result is for.

The transaction manager 112 can store the in-view data in the view data database 138 in reference to the ad space 126 (324). Other methods for determining whether the ad space 126 and the creative for the bidder D are in view in the user interface 124 are possible. For instance, the creative may send to the transaction manager 112 a notification of a click event when the creative is selected by the user 119. In further implementations, the mobile application executing on a client device 120 can use a software development kit (SDK) for determining viewability of ad spaces in the mobile application's user interface. The SDK will including functionality for sending view-ability data to the transaction maager 112.

The model generator 165 or another software component in the server system 122 can use the in-view data to update the prediction model described earlier, for example. In some implementations, the historical viewability data for each feature is updated hourly, with a 24-hour lookback window. In some implementations, the features can include:
1) tag_id
2) site_domain
3) operating_system
4) interactions of all these features with each other
5) bucketed relative position x
6) bucketed relative position y
7) binary prebid_in_view_type flag

The model generator 165 uses the historical view-ability rates of the features to build a logistic regression model that assigns different weights or model co-efficients to each of the features. A new model can be computed every day using the previous day's viewability rates and the model coefficients are updated. These model coefficients are then used along with the historical viewability data to compute the predicted view-ability of all ad spaces for that day. We monitor performance metrics including model prediction accuracy (eg, predicted vs. actual view-rates), overall model prediction bias (eg, total predicted vs. total actual views), etc. and may choose to revert to a previous model if performance seems to have deteriorated considerably. If the newly computed model co-efficients are drastically different from the most recent model, they are not updated.

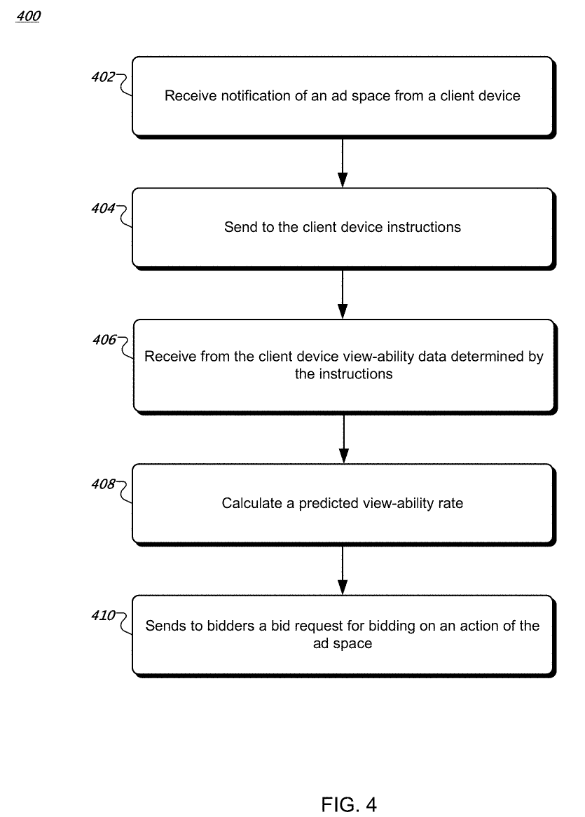

FIG. 4 is a flowchart of another example method for auctioning an available ad space based on a predicted view-ability of the ad space. The method can be implemented using software components executing on one or more data processing apparatus that are part of the data center 121 described earlier, for example. For instance, the method can be implanted using the transaction manager 112. The method begins by receiving a notification of an ad space, the ad space being part of an ad space inventory of a seller, the ad space being for presentation in a user interface of an application executing on a client device of a user (402). The method sends, to the client device, instructions configured to be executed by the client device for determining view-ability data of the ad space, the view-ability data comprising whether the ad space is within a viewport of the user interface (404). The method receives, from the client device, the view-ability data as determined by the instructions at a first time instance (406). The method calculates a predicted view-ability in that the ad space is positioned within the viewport at a second time instance after the first time instance, wherein calculating the predicted view-ability uses a prediction model comprising one or more features (408). The method sends, to a plurality of bidders, a bid request for bidding on an auction of the ad space, the bid request comprising the predicted view-ability (410).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more 202 computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a smart phone, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
performing by one or more server computers:
receiving a notification of an ad space, the ad space being part of an ad space inventory of a seller, the ad space being for presentation in a user interface of an application executing on a client device of a user;
sending, to the client device, instructions configured to be executed by the client device for determining view-ability data of the ad space, the view-ability data comprising whether the ad space is within a viewport of the user interface;
receiving, from the client device, the view-ability data as determined by the instructions at a first time instance;
calculating a predicted view-ability that the ad space is positioned within the viewport at a second time instance after the first time instance, wherein calculating the predicted view-ability uses a prediction model comprising one or more features; and
sending, to a plurality of bidders, a bid request for bidding on an auction of the ad space, the bid request comprising the predicted view-ability.

2. The method of claim 1 further comprising:
receiving, from one or more of the bidders, bids in response to the bid request, each bid comprising a respective bid price as determined by a respective bidder according to the predicted view-ability; and
selecting one of the bids as a winning bid.

3. The method of claim 1, further comprising:
determining whether a creative associated with the winning bid was viewed; and
charging an account associated with the winning bid.

4. The method of claim 1 wherein the view-ability data as determined by the instructions at the first time instance further comprises a position of the ad space relative to the viewport or a size of the viewport.

5. The method of claim 1 wherein a particular feature describes the ad space, the ad space inventory, the application, the client device, or the user.

6. The method of claim 1 wherein a particular feature comprises one or more of an identifier of the ad space, web domain for the ad space, and identifier of the application.

7. The method of claim 1 wherein the prediction model is a logistic function of the features, the logistic function comprising respective coefficients for the features.

8. A system comprising:
one or more computers programmed to perform operations comprising:
receiving a notification of an ad space, the ad space being part of an ad space inventory of a seller, the ad space being for presentation in a user interface of an application executing on a client device of a user;
sending, to the client device, instructions configured to be executed by the client device for determining view-ability data of the ad space, the view-ability data comprising whether the ad space is within a viewport of the user interface;
receiving, from the client device, the view-ability data as determined by the instructions at a first time instance;
calculating a predicted view-ability that the ad space is positioned within the viewport at a second time instance after the first time instance, wherein calculating the predicted view-ability uses a prediction model comprising one or more features; and
sending, to a plurality of bidders, a bid request for bidding on an auction of the ad space, the bid request comprising the predicted view-ability.

9. The system of claim 8 wherein the operations further comprise:
receiving, from one or more of the bidders, bids in response to the bid request, each bid comprising a respective bid price as determined by a respective bidder according to the predicted view-ability; and
selecting one of the bids as a winning bid.

10. The system of claim 8, wherein the operations further comprise:
determining whether a creative associated with the winning bid was viewed; and
charging an account associated with the winning bid.

11. The system of claim 8 wherein the view-ability data as determined by the instructions at the first time instance further comprises a position of the ad space relative to the viewport or a size of the viewport.

12. The system of claim 8 wherein a particular feature describes the ad space, the ad space inventory, the application, the client device, or the user.

13. The system of claim 8 wherein a particular feature comprises one or more of an identifier of the ad space, web domain for the ad space, and identifier of the application.

14. The system of claim 8 wherein the prediction model is a logistic function of the features, the logistic function comprising respective coefficients for the features.

15. An article comprising:
a non-transitory computer-readable medium having instructions stored thereon that, when executed by one or more computers, cause the computers to perform operations comprising:
receiving a notification of an ad space, the ad space being part of an ad space inventory of a seller, the ad space being for presentation in a user interface of an application executing on a client device of a user;
sending, to the client device, instructions configured to be executed by the client device for determining view-ability data of the ad space, the view-ability data comprising whether the ad space is within a viewport of the user interface;
receiving, from the client device, the view-ability data as determined by the instructions at a first time instance;
calculating a predicted view-ability that the ad space is positioned within the viewport at a second time instance after the first time instance, wherein calculating the predicted view-ability uses a prediction model comprising one or more features; and
sending, to a plurality of bidders, a bid request for bidding on an auction of the ad space, the bid request comprising the predicted view-ability.

16. The article of claim 15 wherein the operations further comprise:
receiving, from one or more of the bidders, bids in response to the bid request, each bid comprising a respective bid price as determined by a respective bidder according to the predicted view-ability; and
selecting one of the bids as a winning bid.

17. The article of claim 15, wherein the operations further comprise:
determining whether a creative associated with the winning bid was viewed; and
charging an account associated with the winning bid.

18. The article of claim 15 wherein the view-ability data as determined by the instructions at the first time instance further comprises a position of the ad space relative to the viewport or a size of the viewport.

19. The article of claim 15 wherein a particular feature describes the ad space, the ad space inventory, the application, the client device, or the user.

20. The article of claim 15 wherein a particular feature comprises one or more of an identifier of the ad space, web domain for the ad space, and identifier of the application.

21. The article of claim 15 wherein the prediction model is a logistic function of the features, the logistic function comprising respective coefficients for the features.
